(19) United States
(12) Patent Application Publication
(10) Pub. No.: US 2026/0267065 A1
(43) Pub. Date: Sep. 10, 2026

(54) TURNING ELEMENT ARRAYS FOR OPTICAL INTERFACES

(71) Applicant: Applied Materials, Inc., Santa Clara, CA (US)

(72) Inventors: Zijiao Yang, Fremont, CA (US); Jinxin Fu, Santa Clara, CA (US); Yupeng Zhu, San Jose, CA (US); Guannan Chen, Belmont, CA (US)

(21) Appl. No.: 19/070,397

(22) Filed: Mar. 4, 2025

(51) Int. Cl. G02B 6/122

(52) U.S. Cl. CPC G02B 6/1228

(57) ABSTRACT

An optical interface includes a plurality of inner cores of waveguides, an array of turning elements, wherein each inner core of the plurality of inner cores is associated with a respective turning element of the array of turning elements, and a plurality of spot size converters, wherein each spot size converter of the plurality of spot size converters is associated with a respective turning element of the array of turning elements.

### TECHNICAL FIELD

Embodiments of the present disclosure relate to optical systems, and more particularly to turning element arrays for optical interfaces.

### BACKGROUND

In an optical system, an optical signal can travel through a waveguide (e.g., optical fiber) that is formed from an inner core made of a first material having a first index of refraction and an outer cladding made of a second material having a second index of refraction less than the first index of refraction. For example, the first material and the second material can each be formed from a different type of glass. Thus, when an optical signal traveling in a waveguide is incident on the boundary between the inner core and the outer cladding at an angle exceeding the critical angle, the optical signal can exhibit total internal reflection.

### SUMMARY

In some embodiments, an optical interface includes a plurality of inner cores of waveguides, an array of turning elements, wherein each inner core of the plurality of inner cores is associated with a respective turning element of the array of turning elements, and a plurality of spot size converters, wherein each spot size converter of the plurality of spot size converters is associated with a respective turning element of the array of turning elements.

In some embodiments, a system includes a photonic integrated circuit (PIC), an optical fiber array connector associated with an optical fiber array, and an optical interface between the PIC and the optical fiber array, wherein the optical interface includes a plurality of inner cores of waveguides, an array of turning elements, wherein each inner core of the plurality of inner cores is associated with a respective turning element of the array of turning elements, and a plurality of spot size converters, wherein each spot size converter of the plurality of spot size converters is associated with a respective turning element of the array of turning elements.

Numerous other aspects and features are provided in accordance with these and other embodiments of the disclosure. Other features and aspects of embodiments of the disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-1C are diagrams of views of example systems including co-packaged optical devices, according to some embodiments.

FIG. 2 is a diagram of an example optical interface including a turning element array, according to some embodiments.

FIGS. 3A-3C are diagrams of example turning element arrays for optical interfaces, according to some embodiments.

FIG. 4A-4D are diagrams of an example spot size converters (SSCs) that can be implemented within turning element arrays for optical interfaces, according to some embodiments.

FIGS. 5-6C are diagrams of example implementations of systems that can include optical interfaces with turning element arrays, according to some embodiments.

FIGS. 7A-13C are diagrams of views of example devices implementing detachable optical fiber-to-waveguide coupling, according to some embodiments.

FIGS. 14A-14B are flowcharts of example methods to implement optical interfaces including turning element arrays implementing spot size converters (SSCs), according to some embodiments.

### DETAILED DESCRIPTION

Embodiments of the present disclosure relate to turning element arrays for optical interfaces. A co-packaged device (e.g., multi-chip module) can include a package substrate having multiple PICs assembled closely together. More specifically, optical components can be integrated on substrates (e.g., silicon (Si) substrate) for fabricating large-scale PICs that co-exist with micro-electronic chips. With the use of an optical transceiver, a received optical signal can be converted to an electrical signal capable of being processed by an integrated circuit, or the processed electrical signal can be converted to an optical signal to be transmitted via an optical fiber.

Instead of ICs (e.g., microchips) that utilize electrons to process information, referred to as electronic ICs (EICs), a PIC utilizes photons (light particles) to process information. A PIC can include multiple photonic components connected on a single chip. Examples of components of a PIC include optical signal generators (e.g., lasers) to generate optical signals (e.g., light), waveguides to direct optical signals within the PIC (e.g., similar to wires used to direct electrons), modulators to modulate optical signals to encode information, and detectors to detect and decode the information from the optical signals.

A co-packaged device can include an interconnect device (“interconnect”) disposed between a first component and a second component. For example, an interconnect can be placed between a package substrate and a ball grid array. In some embodiments, an interconnect includes an interposer. An interposer is an electrical interface that routes connections between sockets or connections between the first component and the second component. An interposer can be used to connect components that may not naturally connect to one another. Some interconnects (e.g., interposers) can include multiple conductive layers (e.g., metal layers), where pairs of conductive layers are connected by at least one conductive via (“via”). For example, a first conductive layer of a first metallization level and a second conductive layer of a second metallization level can be connected by at least one via. Some interconnects (e.g., interposers) can further include multiple waveguides, optionally integrated near the conductive layers.

The waveguides of an interconnect can use evanescent wave coupling to transmit an optical signal received from an initial waveguide of the interconnect to a final waveguide of the interconnect. For example, the initial waveguide can be integrated near a bottom conductive layer of the interconnect, and the final waveguide can be integrated near a top conductive layer of the interconnect. Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling can occur when an evanescent wave generated within a waveguide excites an electromagnetic wave in an adjacent waveguide. Evanescent wave coupling can be accomplished when two waveguides are positioned close together such that the evanescent field generated by one of the waveguides reaches the other waveguide before any substantial decay of the evanescent wave is experienced. Generally, an evanescent wave is an oscillating wave (e.g., electromagnetic wave or acoustic wave) generated at a boundary between two media and exists only within a very short distance from the boundary. Evanescent waves can exit the waveguide, and their amplitude can decay exponentially as a function of distance from the boundary. Thus, evanescent waves are generally observable in the near field of the optical signal in close proximity to the boundary.

An optical connection between a fiber or fiber array and the PIC optical waveguide, also referred to herein as a connector, can include a connection substrate having multiple grooves formed therein, into which multiple respective optical fibers can be inserted and secured. Each optical fiber can be optically coupled to a respective waveguide. A connection substrate can be formed with a geometry that can provide the proper spacing to achieve optical coupling (e.g., evanescent wave coupling). For example, a large number of optical fiber-to-waveguide couplings may be needed for a multichannel wavelength division multiplexing (WDM) optical system.

Typically, a PIC implementing a multichannel wavelength division multiplexing (WDM) system includes active components such as modulators, multiplexers, etc. For example, a given modulator can receive an optical signal from an optical signal source, and generate a modulated wave. A set of modulated waves generated from a set of optical signals can be combined using a respective multiplexer to generate a multiplexed wave for a given channel. Such one-to-one optical fiber-to-waveguide connections can require a large number of optical fiber-to-waveguide couplings for a multichannel WDM system. For example, the number of couplings can be n*m, where n is the number of optical signal sources (e.g., light sources) and m is the number of lanes of the multichannel WDM system. Accordingly, it can be difficult to scale up the number of channels in an optical system.

One challenge related to optical input/output (I/O) designs targeted for some types of architectures including PICs and optical fibers, such as artificial intelligence (AI) cluster architectures, is matching of optical bandwidth density with electrical bandwidth density with respect to optical fiber coupling to the optical I/O. In particular, the optical bandwidth density can be lower than the electrical bandwidth density at the interface, and so the limiter can be located on the optical side.

For example, one potential optical fiber coupling solution to the optical I/O is a one-dimensional (1D) approach. One example of a 1D approach is implementing photonic IC edge coupling from embedded optical waveguides to a V-groove array of optical fibers. More specifically, a V-groove array can include a substrate having multiple V-grooves formed therein, where a V-groove is an opening that has a tapered shape in which the sides of the groove converged to a point (e.g., triangular shape). Each optical fiber can be inserted into a V-groove and secured in the V-groove using an adhesive (e.g., glue). The maximum density of these V-groove optical fiber arrays can be a function of optical fiber cladding layer size, which can limit a distance between adjacent optical fibers within the optical fiber array (e.g., optical fiber pitch).

Some surface optical signal coupling solutions can use a grating coupler, formed in a cladding layer formed on a substrate, to direct an incoming optical signal into a waveguide formed by an inner core formed within the cladding layer. However, such coupling solutions can contribute to high loss (e.g., greater than or equal to about 2 decibels (dB)) and small 1-dB bandwidth in wavelength (e.g., less than or equal to about 30 nanometers (nm)). Alternatively, some surface coupling solutions can use a turning element, such as a mirror, formed in a cavity or trench formed within the cladding layer and the substrate, to direct an incoming optical signal into the waveguide formed by an inner core formed within the cladding layer. However, such coupling solutions may require turning element (e.g., mirror) alignment and bonding, which may not meet alignment tolerances for edge coupling (e.g., 1 dB alignment tolerance is typically less than or equal to about 2 μm).

For current optical I/O bandwidth enabled through photonic IC edge coupling to a fiber array, the optical bandwidth density (e.g., optical “beachfront” bandwidth density) can be limited to, e.g., about 1.4 terabits per second per millimeter (Tb/s/mm). This 1.4 Tb/s/mm optical bandwidth density can assume a maximum per-channel bit rate of 200 gigabits per second (Gb/s), a single wavelength per optical fiber, and a minimum optical fiber pitch of 127 micrometers (μm). However, the expected electrical bandwidth density (e.g., electrical “beachfront” bandwidth density) may exceed 10 Tb/s/mm.

Another potential optical fiber coupling solution to the optical I/O is vertical coupling using a two-dimensional (2D) approach. One example of a 2D approach is vertically coupling a grating coupler array to a two-dimensional (2D) optical fiber array. While 2D approaches using grating coupler arrays can enable increased optical bandwidth density as compared to 1D approaches (e.g., the V-groove approach), the potential for higher loss, narrower spectral bandwidth and higher polarization sensitivity of 2D approaches using grating coupler arrays may render them nonviable solutions for scaling optical bandwidth density with electrical bandwidth density.

Aspects and implementations described herein can address these and other drawbacks by providing for turning element arrays for optical interfaces. An array of turning elements described herein can include multiple turning elements formed in respective trenches. For example, the trenches can be formed within a cladding layer. Each turning element can be coupled to a respective inner core. For example, multiple inner cores can be formed within the same cladding layer as the multiple turning elements.

In some embodiments, the array of turning elements has a staggered turning element design. More specifically, the array of turning elements can include multiple sets of turning elements, where the turning elements of a set of turning elements are arranged in a staggered formation (e.g., along a diagonal).

In some embodiments, the array of turning elements has non-staggered turning element design. More specifically, the array of turning elements can include multiple sets of turning elements, where the turning elements of a set of turning elements are colinear (instead of staggered).

For example, the array of turning elements of a non-staggered turning element design can include rotated turning elements. In these embodiments, each inner core can be an angled inner core having a bend. The bend can define a first portion of the inner core prior to the bend, and a second portion of the inner core after the bend. More specifically, the array of turning elements can include multiple sets of turning elements, where the turning elements of a set of turning elements are rotated by an angle relative to the axis corresponding to the first portion of the inner core. In some embodiments, the angle ranges from about 5° to about 45°.

As another example, the array of turning elements of a non-staggered turning element design can include non-rotated turning elements. In these embodiments, at least some of the inner cores can be angled inner cores, where each angled inner core has two bends. The two bends can define a first portion of the inner core prior to the bend, a second portion of the inner core after the first bend, and a third portion of the inner core after the second bend, where the first portion and the second portion are approximately parallel. More specifically, the array of turning elements can include multiple sets of turning elements, where the turning elements of a set of turning elements are not rotated by an angle relative to an axis corresponding to the third portion of the inner core.

In some embodiments, a turning element array is configured to convert a size of an optical mode from a smaller size for propagation (e.g., within the interposer) to a larger size for optical coupling. Illustratively, the smaller size for propagation can be about a 1 μm mode field diameter (MFD), and the larger size for optical coupling can be greater than or equal to about a 5 μm MFD. To achieve this, in some embodiments, an array of turning elements implements spot size converters (SSCs) to convert the size of the optical mode from the smaller size for propagation to the larger size for coupling. More specifically, each SSC can be placed right before a respective turning element. Typically, a longer SSC has less loss than shorter SSC. An SSC can be designed to be approximately straight to avoid bending loss. Therefore, an SSC may not be formed within a bend of an angled inner core. In some turning element designs (e.g., ones in which an angled inner core has at least two bends), one constraint is that the length of the SSC is shorter than trench pitch (e.g., the distance between adjacent trenches). Other turning element designs may not have this constraint, but it can be more beneficial to use shorter SSCs to achieve a more compact layout.

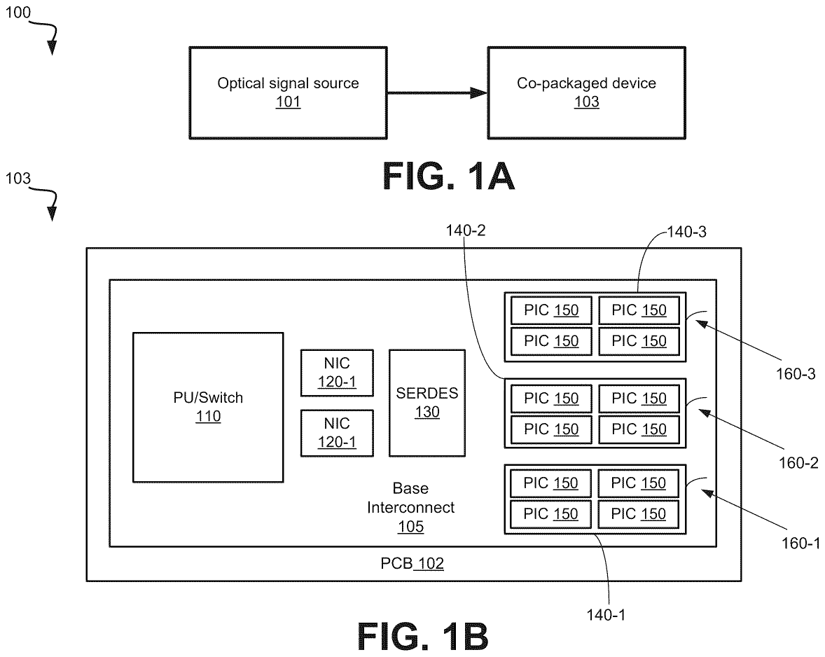

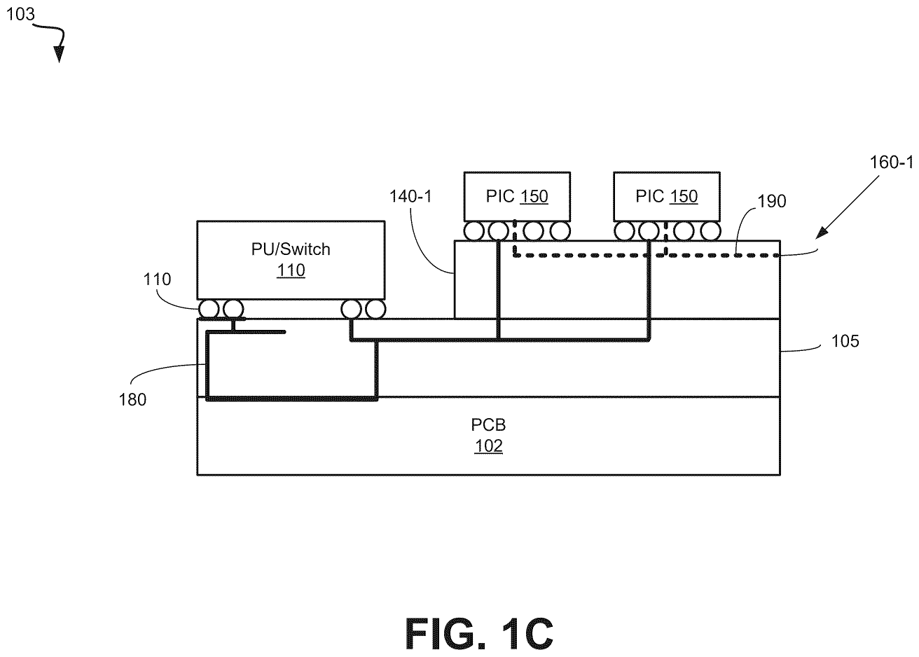

Embodiments described herein can provide for numerous other technical advantages. For example, embodiments described herein can reduce evanescent wave decay within devices (e.g., interconnects), which can improve the ability of waveguides of these devices to transmit optical signals. Embodiments described herein can reduce the size of a PIC, which can reduce costs, and enable more PICs to be used per area on the interconnect to increase the area bandwidth density. Further details regarding turning element arrays for optical interfaces will now be described below with reference to FIGS. 1-14B.

FIG. 1A is a block diagram of system 100, according to some embodiments, As shown, the system 100 can include optical signal source 101 and co-packaged device 103. Optical signal source 101 can provide, as input to co-packaged device, multiple wavelengths of optical signals (e.g., multiple wavelengths of light). For example, optical signal source 101 can include multiple optical signal generators (e.g., lasers) that each generate a respective wavelength of an optical signal. An example of co-packaged device 103 will now be described below with reference to FIGS. 1B-1C.

FIGS. 1B-1C are block diagrams of views of co-packaged device 103, according to some embodiments. More specifically, FIG. 1B is a top-down view of co-packaged device 103, and FIG. 1C is a side view of co-packaged device 103.

As shown in FIG. 1B, co-packaged device 103 can include printed circuit board (PCB) 102, base interconnect (e.g., interposer) 105, at least one processing unit and/or switch (PU/switch) 110 disposed on base interconnect 105, at least one network interface card (NIC) 120 disposed on base interconnect 105, serializer-deserializer (SERDES) 130 disposed on base interconnect 105, multiple interconnects 140-1 through 140-3 disposed on base interconnect 105, multiple photonic integrated circuits (PICs) 150 disposed on each of interconnects 140-1 through 140-3, and multiple waveguides 160-1 through 160-3 each coupled to a respective one of interconnects 140-1 through 140-3. In some embodiments, and as shown, the number of interconnects is three. However, the number of interconnects should not be considered limiting. In some embodiments, and as shown, each set of PICs 750s includes four PICs. However, the number of PICs should not be considered limiting.

More specifically, each of interconnects 140-1 through 140-3 can be disposed between respective sets of PICs 150 and base interconnect 105. For example, as further shown in FIG. 1C, bumps 170 are disposed between PU/Switch 110 and base interconnect 105, and between PICs 150 and interconnects 140-1 through 140-3. Conductive wires 180 can be formed through the base interconnect 105 and the interconnects 140-1 through 140-3 to enable electrical connections between components of co-packaged device 103 (e.g., PU/switch 110 and PICs 150). Additionally, through each of interconnects 140-1 through 140-3, a respective waveguide system 180 can be formed to provide optical signals to the PICs 150.

FIG. 2 is a diagram of an example system 200, according to some embodiments. As shown in FIG. 2, the system 200 includes a substrate 210. In some embodiments, the substrate 210 is an interposer substrate (e.g., a PIC interposer substrate).

The system 200 can further include an optical interface, formed on the substrate 210. The optical interface can include a cladding layer 220 formed on the substrate 210. The cladding layer 220 can include any suitable dielectric material. In some embodiments, the cladding layer 220 is formed from an oxide material. For example, the cladding layer 220 can be formed from silicon dioxide (SiO₂).

The cladding layer 220 can include multiple turning elements including turning elements 222-1 through 222-3, forming an array of turning elements. Each turning element is formed within a respective trench of an array of trenches. For example, a trench can be a micro-trench. Each turning element may include a reflective material (e.g., metal reflector) formed within a respective trench of the cladding layer 220 (e.g., dropped within a respective trench or formed on an angled trench wall of a respective trench). In some embodiments, the turning element is a mirror.

Multiple parallel inner cores, including inner cores 224-1 through 224-3, can be formed within the cladding layer 220 to form multiple parallel waveguides, and each turning element can be coupled (e.g., edge coupled) to a respective inner core of the multiple parallel inner cores. For example, the turning element 222-1 can be coupled to the inner core 224-1, the turning element 222-2 can be coupled to the inner core 224-2, and the turning element 222-3 can be coupled to the inner core 224-3. The multiple parallel inner cores can be formed from any suitable material. The multiple parallel inner cores can have a higher refractive index than the cladding layer 220 to form effective optical waveguides. In some embodiments, each inner core is formed from silicon nitride (Si₃N₄).

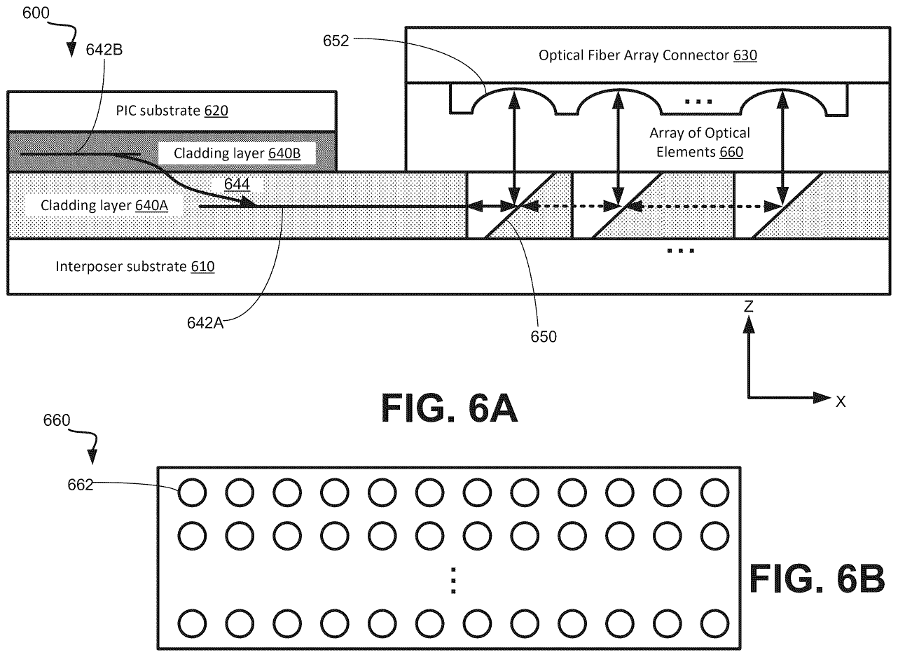

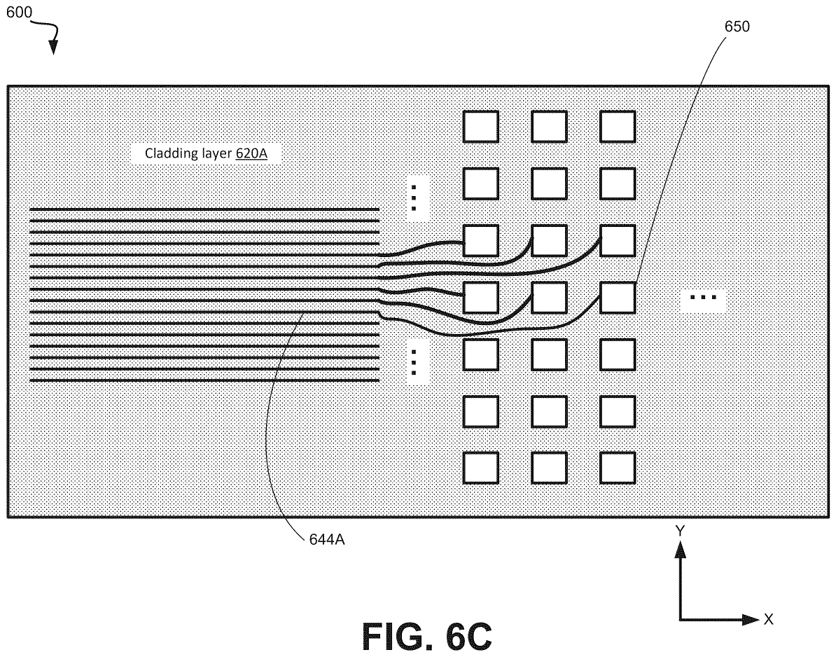

Each turning element can enable a beam to be reflected in a perpendicular direction relative to the inner core (e.g., vertical direction). Thus, the turning element array can enable 2D fiber array coupling (multiple rows and columns). An example of 2D fiber array coupling will be described below with reference to FIGS. 6A-6C.

In some embodiments, the turning element pitch (e.g., distance between adjacent turning elements) is greater than or equal to about 50 μm. In some embodiments, an angle of an optical wave or beam reflected off a turning element ranges from about 30° to about 60°. In some embodiments, an angle of a beam reflected off a turning element is about 45°. In some embodiments, a turning element has a straight surface to expand a beam reflected off the turning element. In some embodiments, a turning element has a curved surface to collimate a beam reflected off the turning element.

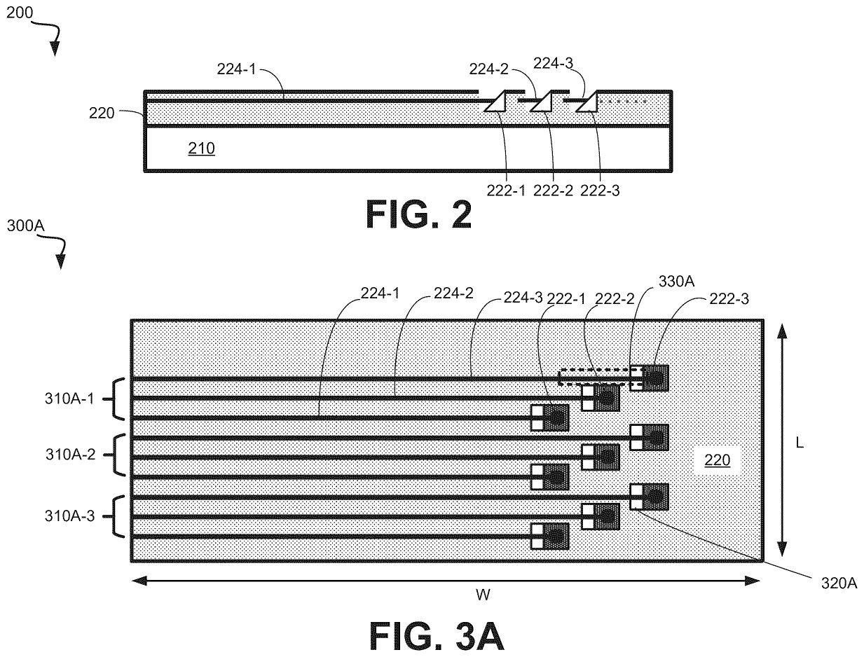

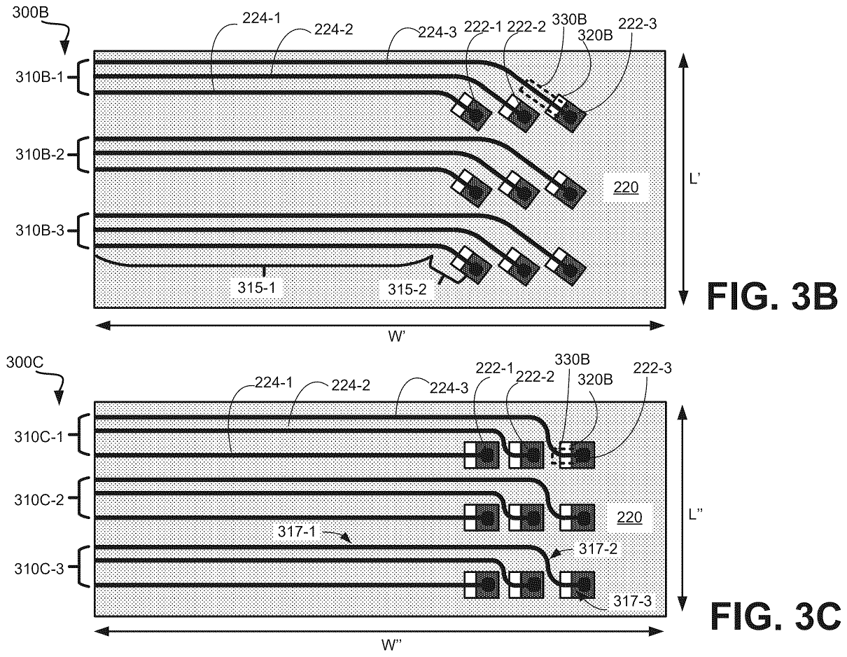

In some embodiments, the array of turning elements has a staggered turning element design. More specifically, the array of turning elements can include multiple sets of turning elements, where the turning elements of a set of turning elements are arranged in a staggered formation (e.g., along a diagonal). Further details regarding the staggered turning element design will now be described below with reference to FIG. 3A.

FIG. 3A is a diagram of a top-down view of an example system 300A, according to some embodiments. For example, the system 300A can include the cladding layer 220 described above with reference to FIG. 2, an array of turning elements including the turning elements 222-1 through 222-3 described above with reference to FIG. 2, and multiple sets of inner cores including sets of inner cores 310A-1 through 310A-3 formed within the cladding layer 220, where the inner cores of a set of inner cores are coupled with respective turning elements formed in respective trenches including trench 320A. For example, the set of inner cores 310A-1 includes the waveguides 224-1 through 224-3 coupled to the turning elements 222-1 through 222-3 described above with reference to FIG. 2. Although each set of inner cores is shown including three inner cores coupled to three turning elements, the number of waveguides of a set of waveguides should not be considered limiting.

In this illustrative embodiment, the array of turning elements has a staggered turning element design. More specifically, the turning elements of a set of turning elements (e.g., the turning elements 222-1 through 222-3) are arranged in a staggered formation (e.g., along a diagonal).

In some embodiments, and as shown in FIG. 3A, SSCs including SSC 330A are implemented within the system 300A. The SSCs including SSC 330A can have any suitable design in accordance with embodiments described herein. In some embodiments, the SSC 330A has a linear design. In some embodiments, the SSC 330A has a polynomial design. In some embodiments, the SSC 330A has a two-layer design. In some embodiments, the SSC 330A has a trident design. In some embodiments, each SSC has the same design. In some embodiments, at least one SSC has a different design from the other SSCs.

The system 300A can have an associated length “L” and width “W”. The length L defines a length of a channel shoreline (“shoreline”) having an associated shoreline channel density. The shoreline refers to a region along an edge of the system 300A along which waveguides are formed. Various metrics can be used to define the shoreline channel density.

For example, the shoreline channel density can be defined based on number of columns with a corresponding inner core pitch. The inner core pitch is the distance between adjacent inner cores (e.g., the distance between inner core 222-1 and inner core 222-2). Illustratively, the following table illustrates estimated numbers of columns for various example combinations of trench pitches and turning mirror pitches with a corresponding 10 μm inner core pitch:

TABLE 1

| | 127 μm turning | 250 μm turning |
|---|---|---|
| | mirror pitch | mirror pitch |
| 30 μm trench pitch | 5 columns | 10 columns |
| 50 μm trench pitch | 3 columns | 7 columns |
| 70 μm trench pitch | 3 columns | 6 columns |

As another example, the shoreline channel density can be defined based on the length L that can enable a given number of channels. Illustratively, the following table illustrates estimated shoreline lengths “L” with corresponding shoreline widths “W” (represented in the table as “L (W) mm”) for various example combinations of trench pitches and turning mirror pitches that can enable 1000 channels:

TABLE 2

| | 127 μm turning | 250 μm turning |
|---|---|---|
| | mirror pitch | mirror pitch |
| 30 μm trench pitch | 25.4 (0.5) mm | 25.0 (2.2) mm |
| 50 μm trench pitch | 42.3 (0.2) mm | 35.7 (1.5) mm |
| 70 μm trench pitch | 42.3 (0.2) mm | 41.2 (1.2) mm |

As yet another example, the shoreline channel density can be defined based on the number of channels per unit distance (e.g., per mm) along the length L with a corresponding inner core pitch. Illustratively, for the 127 μm turning mirror pitch and a 30 μm trench pitch, the shoreline can have an approximate length of 25.4 mm and an approximate width of 0.5 mm. Similarly, for the 50 μm trench pitch, the shoreline can have an approximate length of 42.3 mm and an approximate width of 0.2 mm. Similarly, for the 70 μm trench pitch, the shoreline can have an approximate length of 42.3 mm and an approximate width of 0.2 mm. Illustratively, for the 250 μm turning mirror pitch and a 30 μm trench pitch, the shoreline can have an approximate length of 25.0 mm and an approximate width of 2.2 mm. Similarly, for the 50 μm trench pitch, the shoreline can have an approximate length of 357 mm and an approximate width of 1.5 mm. Similarly, for the 70 μm trench pitch, the shoreline can have an approximate length of 41.2 mm and an approximate width of 1.2 mm. It is appreciated that the above measurements are examples of approximate values for the turning mirror pitch, trench pitch, and length and width of the shoreline, and are not intended to limit embodiments. Other embodiments may have similar values, ratios between values, or the like.

Illustratively, the following table illustrates estimated numbers of channels per mm for various example combinations of trench pitches and turning mirror pitches with a corresponding 10 μm inner core pitch:

TABLE 3

| | 127 μm turning | 250 μm turning |
|---|---|---|
| | mirror pitch | mirror pitch |
| 30 μm trench pitch | 39 channels per mm | 40 channels per mm |
| 50 μm trench pitch | 24 channels per mm | 28 channels per mm |
| 70 μm trench pitch | 24 channels per mm | 24 channels per mm |

In some embodiments, the array of turning elements has non-staggered turning element design. More specifically, the array of turning elements can include multiple sets of turning elements, where the turning elements of a set of turning elements are colinear (instead of staggered).

For example, the array of turning elements of a non-staggered turning element design can include rotated turning elements. In these embodiments, each inner core can be an angled inner core having a bend. The bend can define a first portion of the inner core prior to the bend, and a second portion of the inner core after the bend. More specifically, the array of turning elements can include multiple sets of turning elements, where the turning elements of a set of turning elements are rotated by an angle relative to the axis corresponding to the first portion of the inner core. In some embodiments, the angle ranges from about 5° to about 45°. In these embodiments, each inner core can be an angled inner core having a bend. Further details regarding a non-staggered turning element design including rotated turning elements will now be described below with reference to FIG. 3B.

FIG. 3B is a diagram of a top-down view of an example system 300B, according to some embodiments. For example, the system 300B can include the cladding layer 220 described above with reference to FIG. 2, an array of turning elements including the turning elements 222-1 through 222-3 described above with reference to FIG. 2, and multiple sets of inner cores including sets of inner cores 310B-1 through 310B-3 formed within the cladding layer 220, where the inner cores of a set of inner cores are coupled with respective turning elements formed in respective trenches including trench 320B. For example, the set of inner cores 310B-1 includes the waveguides 224-1 through 224-3 coupled to the turning elements 222-1 through 222-3 described above with reference to FIG. 2. Although each set of inner cores is shown including three inner cores coupled to three turning elements, the number of waveguides of a set of waveguides should not be considered limiting.

In this illustrative embodiment, each inner core can include at least one bend for coupling to its respective turning element. The bend can define a first portion of the inner core prior to the bend, portion 315-1, and a second portion of the inner core after the bend, portion 315-2. The array of turning elements can have a non-staggered turning element design including rotated turning elements. More specifically, the turning elements of a set of turning elements (e.g., the turning elements 222-1 through 222-3) are arranged in a non-staggered formation (e.g., colinear) and are rotated by an angle relative to the axis corresponding to the portion 315-1. In some embodiments, the angle ranges from about 5° to about 45°.

In some embodiments, and as shown in FIG. 3B, SSCs including SSC 330B are implemented within the system 300B. The SSCs including SSC 330B can have any suitable design in accordance with embodiments described herein. In some embodiments, the SSC 330B has a linear design. In some embodiments, the SSC 330B has a polynomial design. In some embodiments, the SSC 330B has a two-layer design. In some embodiments, the SSC 330B has a trident design. In some embodiments, each SSC has the same design. In some embodiments, at least one SSC has a different design from the other SSCs.

The system 300B can have an associated length “L′” and width “W′”. The length L′ defines a length of a channel shoreline having an associated shoreline channel density. Various metrics can be used to define the shoreline channel density.

For example, the shoreline channel density can be defined based on number of columns with a corresponding turning mirror footprint area. Illustratively, the following table illustrates estimated numbers of columns for various example combinations of inner core pitches and turning mirror pitches with a corresponding 30 μm×30 μm turning mirror footprint area:

TABLE 4

| | 127 μm turning | 250 μm turning |
|---|---|---|
| | mirror pitch | mirror pitch |
| 10 μm inner core pitch | 11 columns | 23 columns |
| 20 μm inner core pitch | 6 columns | 12 columns |
| 40 μm inner core pitch | 3 columns | 6 columns |

As another example, the shoreline channel density can be defined based on the length L that can enable a given number of channels. Illustratively, the following table illustrates estimated lengths L′ for various example combinations of inner core pitches and turning mirror pitches that can enable 1000 channels:

TABLE 5

| | 127 μm turning | 250 μm turning |
|---|---|---|
| | mirror pitch | mirror pitch |
| 10 μm inner core pitch | 11.5 (1.3) mm | 10.9 (5.5) mm |
| 20 μm inner core pitch | 21.2 (0.6) mm | 20.8 (2.8) mm |
| 40 μm inner core pitch | 42.3 (0.2) mm | 41.7 (1.2) mm |

As yet another example, the shoreline channel density can be defined based on the number of channels per unit distance (e.g., per mm) along the length L with a corresponding turning mirror footprint area. Illustratively, the following table illustrates estimated numbers of channels per mm for various example combinations of inner core pitches and turning mirror pitches with a corresponding 30 μm×30 μm turning mirror footprint area:

TABLE 6

| | 127 μm turning | 250 μm turning |
|---|---|---|
| | mirror pitch | mirror pitch |
| 10 μm inner core pitch | 87 channels per mm | 92 channels per mm |
| 20 μm inner core pitch | 47 channels per mm | 48 channels per mm |
| 40 μm inner core pitch | 24 channels per mm | 24 channels per mm |

As another example, the array of turning elements of a non-staggered turning element design can include non-rotated turning elements. In these embodiments, at least some of the inner cores can be angled inner cores, where each angled inner core has two bends. The two bends can define a first portion of the inner core prior to the bend, a second portion of the inner core after the first bend, and a third portion of the inner core after the second bend, where the first portion and the second portion are approximately parallel. More specifically, the array of turning elements can include multiple sets of turning elements, where the turning elements of a set of turning elements are not rotated by an angle relative to an axis corresponding to the third portion of the inner core. In these embodiments, the length of an SSC implemented within the array of turning elements can be shorter than the trench pitch or width. Further details regarding a non-staggered turning element design including non-rotated turning elements will be described below with reference to FIG. 3C.

FIG. 3C is a diagram of a top-down view of an example system 300C, according to some embodiments. For example, the system 300C can include the cladding layer 220 described above with reference to FIG. 2, an array of turning elements including the turning elements 222-1 through 222-3 described above with reference to FIG. 2, and multiple sets of inner cores including sets of inner cores 310C-1 through 310C-3 formed within the cladding layer 220, where the inner cores of a set of inner cores are coupled with respective turning elements formed in respective trenches including trench 320B. For example, the set of inner cores 310C-1 includes the waveguides 224-1 through 224-3 coupled to the turning elements 222-1 through 222-3 described above with reference to FIG. 2. Although each set of inner cores is shown including three inner cores coupled to three turning elements, the number of waveguides of a set of waveguides should not be considered limiting.

In this illustrative embodiment, each inner core can include two bends for coupling to its respective turning element. The two bends can define a first portion of the inner core prior to the first bend, portion 317-1, a second portion of the inner core after the first bend, portion 317-2, and a third portion of the inner core after the second bend, portion 317-3. The array of turning elements can have a non-staggered turning element design including non-rotated turning elements. More specifically, the turning elements of a set of turning elements (e.g., the turning elements 222-1 through 222-3) are arranged in a non-staggered formation (e.g., colinear) and are not rotated by an angle relative to an axis corresponding to the portion 317-3.

In some embodiments, and as shown in FIG. 3C, SSCs including SSC 330C can be implemented within the system 300C. The SSCs including SSC 330C can have any suitable design in accordance with embodiments described herein. In some embodiments, the SSC 330C has a linear design. In some embodiments, the SSC 330C has a polynomial design. In some embodiments, the SSC 330C has a two-layer design. In some embodiments, the SSC 330C has a trident design. In some embodiments, each SSC has the same design. In some embodiments, at least one SSC has a different design from the other SSCs.

The system 300C can have an associated length “L“ ” and width “W” “. The length L” defines a length of a channel shoreline having an associated shoreline channel density. Various metrics can be used to define the shoreline channel density.

For example, the shoreline channel density can be defined based on number of columns with a corresponding turning mirror footprint area (e.g., similar to Table 4 described above with reference to FIG. 3B). As another example, the shoreline channel density can be defined based on the length L that can enable a given number of channels (e.g., similar to Table 5 described above with reference to FIG. 3B). As yet another example, the shoreline channel density can be defined based on the number of channels per unit distance (e.g., per mm) along the length L with a corresponding turning mirror footprint area (e.g., similar to Table 6 described above with reference to FIG. 3B).

In some embodiments, a radius of a bend (bending radius) is larger than the trench pitch to minimize radiation loss from a waveguide. In some embodiments, no bending is needed inside of the turning mirror pitch (e.g., 127 μm pitch or 250 μm pitch).

The staggered turning element design allows for fewer bends, but the number of columns could be less than the other designs. The number of columns in the staggered turning element design can be limited by the trench pitch. In some embodiments, the trench pitch ranges from about 10 μm to about 60 μm for an etched turning element on substate, and greater than or equal to about 40 μm for an integrated turning element (e.g., with a microlens).

Non-staggered designs (e.g., in the examples shown in FIGS. 3B-3C) can allow for a higher number of columns than the staggered design, where the number of columns can be limited by the ratio between trench pitch and inner core pitch. The minimum inner core pitch can be determined by crosstalk specifications. In some embodiments, the minimum inner core pitch is less than or equal to about 10 μm).

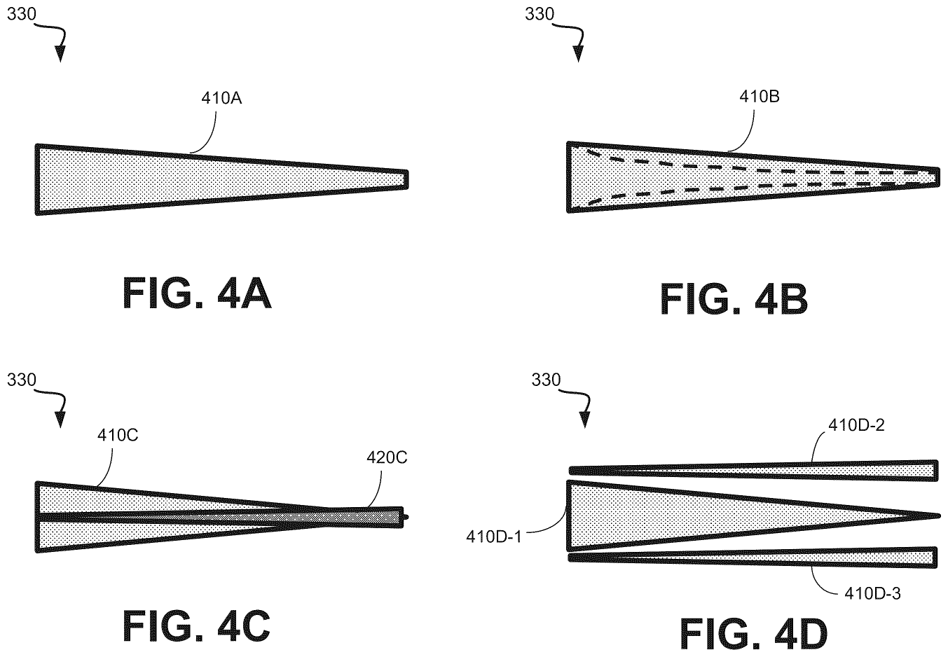

FIG. 4A-4D are diagrams of an example SSCs that can be implemented within turning element arrays of optical interfaces, according to some embodiments.

For example, FIG. 4A is a diagram of an SSC 330 having a linear design. In particular, the SSC 330 is formed from a single layer of inner core material 410A having a linear tapered profile.

FIG. 4B is a diagram of an SSC 330 having a polynomial design. In particular, the SSC 330 is formed from a single layer of inner core material 410B having a tapered profile defined by a polynomial function, as indicated by the dashed lines.

FIG. 4C is a diagram of an SSC 330 having a dual layer design. In particular, the SSC 330 is formed from a first layer of inner core material 410C having a first tapered profile, and a second layer of inner core material having a second tapered profile formed between portions of the first layer of inner core material 410C.

FIG. 4D is a diagram of an SSC 330 having a trident design. In particular, the SSC 330 is formed from inner core material layers 410D-1 through 410D-3. The inner core material layer 410D-1 has a first tapered profile, and the inner core material layers 410D-2 and 410D-3 each have a second tapered profile.

The following table shows illustrative examples of loss for example lengths of different designs of SSCs:

TABLE 7

| SSC design | Loss (dB) | Length (μm) |
|---|---|---|
| Linear | 0.04/0.22 | 1100/300 |
| Polynomial | 0.04/0.22 | 260/130 |
| Two-layer | 0.04/0.22 | 180/60 |
| Trident | 0.05 | 100 |

As illustrated in the table 7, in a linear SSC design, the loss for a 1100 μm length is .04 dB, and the loss for a 300 μm length is .22 dB. In a polynomial SSC design, the loss for a 260 μm length is .04 dB, and the loss for a 130 μm length is .22 dB. In a two-layer SSC design, the loss for a 180 μm length is .04 dB, and the loss for a 60 μm length is .22 dB. In a trident SSC design, the loss for a 100 μm length is .05 dB.

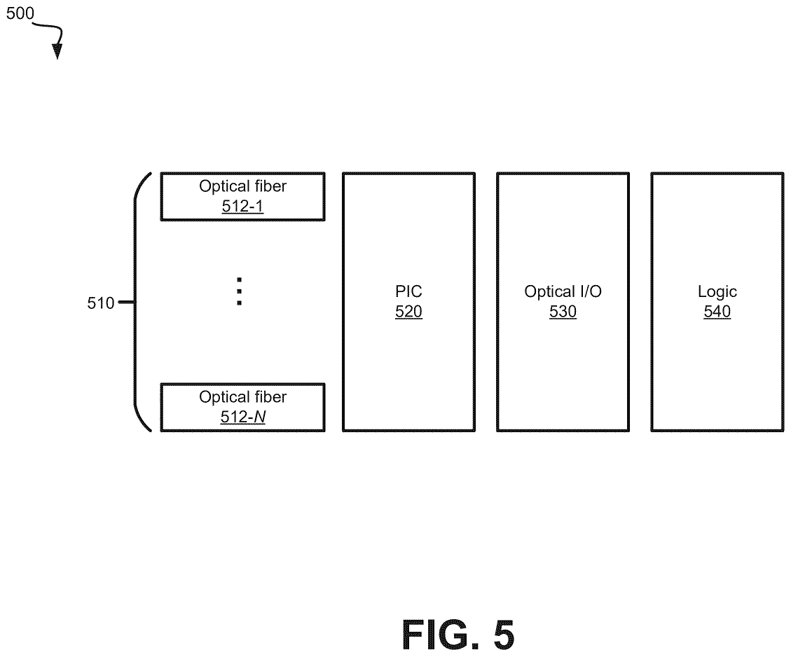

FIG. 5 is a block diagram of a top-down view of an example system 500, according to some embodiments. As shown, the system 500 can include an optical fiber array 210 including N optical fibers 512-1 through 512-N. The system 500 can further include at least one PIC 520, optical I/O 530 and logic 540. The system 500 can correspond to an AI cluster architecture in some embodiments. As described above, the expected electrical bandwidth density (e.g., electrical “beachfront” bandwidth density) associated with the logic 540 may exceed 10 Tb/s/mm. As will now be described below with reference to FIGS. 6A-6C, an optical interface between a PIC and an optical fiber array can be used to achieve optical bandwidth densities that are greater than or equal to about 10 Tb/s/mm to match electrical bandwidth densities.

FIG. 6A is a diagram of cross-sectional view of an example system 600, according to some embodiments. As shown in FIG. 6A, the system 600 can include an interposer substrate 610 of an interposer, a PIC substrate 620 of a PIC, and an optical fiber array connector 630 associated with an optical fiber array (e.g., the optical fiber array 510 of FIG. 5). The interposer substrate 610 and the PIC substrate 620 can be formed from any suitable material. In some embodiments, at least one of the interposer substrate 610 or the PIC substrate 620 is a silicon (Si) substrate.

FIG. 6B is a diagram of a bottom-up view of an example optical fiber array connector 660, according to some embodiments. As shown in FIG. 6B, the optical fiber array connector 660 includes multiple channels 662 arranged in rows. In this illustrative embodiment, each row includes 12 channels. In some embodiments, there are 6 rows that each include 12 channels (i.e., 72 channels). However, the number of channels, rows of channels and/or number of channels within each row should not be considered limiting.

Referring back to FIG. 6A, the system 600 can further include an optical interface, formed on the interposer substrate 610, between the PIC substrate 620 and the optical fiber array connector 630. The optical interface can include a cladding layer 640A formed on the interposer substrate. The cladding layer 640A can include any suitable dielectric material. In some embodiments, the cladding layer 640A is formed from an oxide material. For example, the cladding layer 640A can be formed from SiO₂. More specifically, the cladding layer 640A can be a thick cladding layer. The cladding layer 640A can have any suitable thickness. In some embodiments, the thickness of the cladding layer 640A ranges from about 5 μm to about 20 μm.

The cladding layer 640 can include multiple (e.g., an array of) small trenches. For example, a trench can be a micro-trench. Each trench of the cladding layer 640A can have a turning element 650 formed therein. Each turning element 650 may include a reflective material (e.g., metal reflector) formed within a respective trench of the cladding layer 640A (e.g., formed on an angled trench wall of a respective trench). In some embodiments, the turning element 650 is a mirror. For example, the turning element 650 can be an angled mirror formed along an angled sidewall of its corresponding trench.

Multiple parallel inner cores, including inner core 642A, can be formed within the cladding layer 640A to form multiple parallel waveguides, and each turning element can be coupled (e.g., edge coupled) to a respective inner core of the multiple parallel inner cores (e.g., the turning element 650 coupled to the inner core 642A). The multiple parallel inner cores, including the inner core 642A, can be formed from any suitable material. The multiple parallel inner cores, including the inner core 642A, can have a higher refractive index than the cladding layer 640A to form effective optical waveguides. In some embodiments, the inner core 642A is formed from Si₃N₄.

FIG. 6C is a diagram of a top-down view of the system 600 showing example connections between the multiple inner cores including the inner core 344A and respective ones of the turning elements including the turning element 650, according to some embodiments.

Referring back to FIG. 6A, the optical interface can further include an array of optical elements 660 formed on the thick cladding layer. The array of optical elements 660 can function as optical I/O to the optical fibers. For example, the array of optical elements 660 can collimate light to increase alignment tolerance. More specifically, each optical element of the array of optical elements 660 can direct and/or refocus light redirected by a respective turning element (e.g., reflected off a respective angled mirror) toward a respective optical fiber of an optical fiber array associated with the optical fiber array connector 630. The array of optical elements 660 can include any suitable optical elements and/or combinations of optical elements in accordance with embodiments described herein.

In some embodiments, the array of optical elements 660 is a 2D lens array. For example, the array of optical elements 660 can include one or more metalenses (e.g., an array of metalenses). A metalens is an ultra-thin, flat optical element that can focus or manipulate light. For example, a metalens can interact with light, altering its phase, amplitude, or polarization. By precisely controlling the shape, size, and arrangement of a metalens, the metalens can be designed to achieve various optical functions, such as focusing, beam shaping, creating holographic images, etc. Multiple metalenses can form a metalens array on the backside of the PIC. A metalens can have sub-wavelength dimensions. In some embodiments, a metalens has a dimension that ranges from about 0.5 micrometer (μm) to about 2 μm. A metalens can be formed from any suitable material. The type of material can depend on a variety factors, such as target wavelength (visible light, infrared, etc.), efficiency, ease of fabrication, cost, etc. Examples of materials that can be used to form a metalens include silicon (Si), dielectric materials (e.g., titanium dioxide (TiO₂) and gallium nitride (GaN)), semiconductor materials (e.g., silicon nitride (SiN) and zinc selenide (ZnSe)), phase-change materials (e.g., germanium-antimony-tellurium (GST) and vanadium dioxide (VO₂)), transition metal dichalcogenides (e.g., molybdenum disulfide (MoS₂), tungsten disulfide (WS₂), tungsten diselenide (WSe₂), molybdenum ditelluride (MoTe₂), rhenium disulfide (ReS₂)), carbon (C) (e.g., graphene), metals (e.g., gold (Au) and silver (Ag)), etc.

As another example, the array of optical elements 660 can include one or more microlenses (e.g., an array of microlenses). A microlens can have a sphere or hemisphere shape that can function based on similar principles as a traditional curved lens. A microlens can have a diameter typically less than 1 mm. In some embodiments, a microlens has a diameter that ranges from about 100 μm to about 200 μm. The small size of microlenses can enable microlenses to focus light onto specific points. Microlenses can be formed from polymers, glass or other suitable optical materials. The type of material can depend on a variety factors, such as target wavelength (visible light, infrared, etc.), application (imaging, sensing, light coupling, etc.) efficiency, ease of fabrication, cost, etc. Examples of polymers that can be used to form a microlens include polymethl methacrylate (PMMA), polycarbonate (PC), epoxy, etc. Examples of glasses that can be used to form a microlens include Si, fused silica (SiO₂), chalcogenide glass, other optical glasses, etc.

In some embodiments, and as shown in FIG. 6A, an additional cladding layer 640B is formed on the cladding layer 640A. The additional cladding layer 640B can include any suitable dielectric material. In some embodiments, the additional cladding layer 640B is formed from an oxide material. For example, the additional cladding layer 640B can be formed from SiO₂. The additional cladding layer 640B can have a smaller thickness than the cladding layer 640A.

Multiple inner cores (e.g., tapered inner cores) (e.g., inner core 642B) can be formed within the additional cladding layer 640B to form multiple waveguides (e.g., tapered waveguides). Each of the inner cores formed within the cladding layer 640B can be configured to enable evanescent wave coupling of an optical signal with respect to a respective inner core formed within the cladding layer 640A (e.g., evanescent wave coupling between the inner core 642A and the inner core 642B, as indicated by the arrow 644). The inner core 642B can be formed from any suitable material. The material of the inner core 642B can have a higher refractive index than the additional cladding layer 640B to form an effective optical waveguide. In some embodiments, the inner core 642B is formed from Si₃N₄.

In some embodiments, the cladding layer 640B is hybrid bonded to the cladding layer 640A. Hybrid bonding refers to an advanced chip integration technique that combines both electrical and mechanical bonding at the wafer or die level. Hybrid bonding can allow for two components (e.g., wafers and/or chips) to be directly connected to each other by creating nanoscale interconnections, which can enable higher density, better performance, and lower power consumption as compared to traditional bonding techniques such as wire bonding, flip-chip bonding, etc.

In some embodiments, the minimum pitch of turning elements (e.g., in the vertical direction when viewing the interposer from a top-down view) can be determined based at least in part on a minimum optical fiber pitch. The number of columns of turning elements (e.g., in the horizontal direction when viewing the interposer from a top-down view) can be determined based at least in part by a minimum mirror width (e.g., process-defined), and the maximum optical waveguide density that can be routed between turning elements. Illustratively, for a 1D array of waveguides within the thick cladding layer, a 10 μm waveguide pitch within the thick cladding layer can be considered safe. For example, “safe” refers to the minimum safe distance between optical waveguides that ensures no unwanted optical coupling between adjacent waveguides. If the spacing were reduced below 10 μm, then there is greater probability for optical crosstalk between adjacent waveguides. Such a pitch can limit the maximum number of columns of turning elements to 11. Assuming a 127 μm pitch for the turning elements, a 200 gigabit/lane bandwidth, 11 columns of turning elements, and 7 turning elements per column within a 1 mm interposer shoreline, the maximum optical bandwidth density that can be achieved using the optical interface can be approximately 15.4 Tb/s/mm. Accordingly, optical interfaces described herein can achieve optical bandwidth densities that are greater than or equal to about 10 Tb/s/mm to match electrical bandwidth densities Accordingly, the optical interface shown in FIGS. 6A and 6C can be used to achieve optical bandwidth densities that are greater than or equal to about 10 Tb/s/mm to match electrical bandwidth densities.

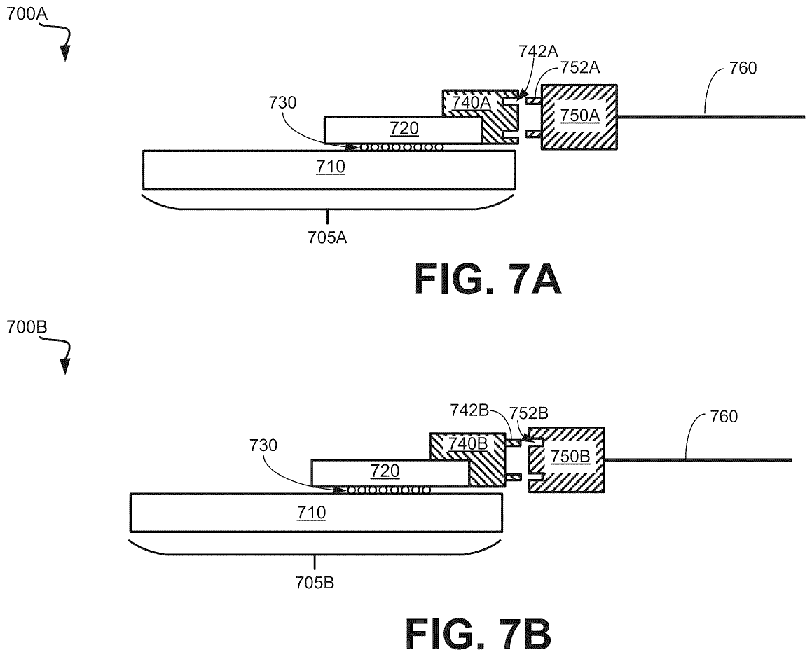

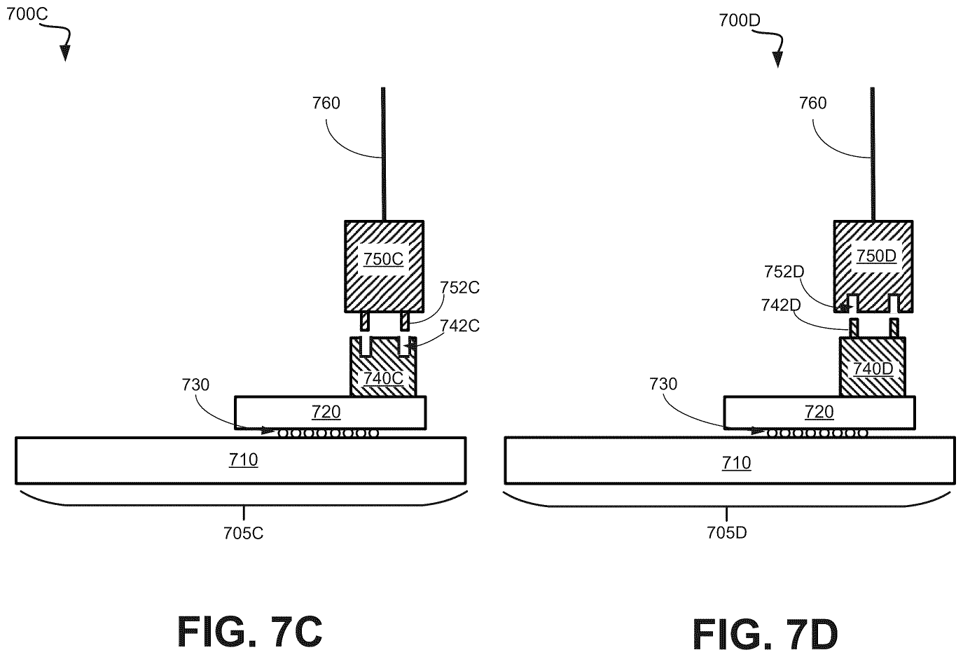

FIG. 7A is a diagram of system 700A, according to some embodiments. As shown in FIG. 7A, system 700A can include device 705A including substrate 710, at least one photonic integrated circuit (PIC) 720, ball grid array 730 formed between substrate 710 and PIC 720, and connection component 740A integrated within device 705A. More specifically, connection component 740A is formed on PIC 720. System 700A further includes connection component 750A coupled to optical fiber 760.

In this illustrative example, connection component 740A is a female connection component having a set of openings including opening 742A. Connection component 750A is a male connection component having a set of protrusions including protrusion 752A. Each opening of the set of openings of connection component 740A is designed to receive a respective protrusion of the set of protrusions of connection component 750A. For example, opening 742A is designed to receive protrusion 752A.

System 700A enables optical fiber-to-waveguide coupling on a plane parallel to an upper surface of substrate 710 (e.g., horizontal coupling). For example, connection component 740A is attached to PIC 720 in a manner enables the connection component 750A to be received along the plane parallel to the upper surface of substrate 710.

FIG. 7B is a diagram of a device or system 700B, according to some embodiments. As shown in FIG. 7B, system 700B can include device 705B including substrate 710, at least one PIC 720, ball grid array 730 formed between substrate 710 and PIC 720, and connection component 740B integrated within device 705B. More specifically, connection component 740B is formed on PIC 720. System 700B further includes connection component 750B coupled to optical fiber 760.

In this illustrative example, connection component 740B is a male connection component having a set of protrusions including protrusion 742B. Connection component 750B is a female connection component having a set of openings including opening 752B. Each opening of the set of openings of connection component 750B is designed to receive a respective protrusion of the set of protrusions of connection component 740B. For example, opening 752B is designed to receive protrusion 742B.

System 700B enables optical fiber-to-waveguide coupling on a plane parallel to an upper surface of substrate 710 (e.g., horizontal coupling). For example, connection component 740B is attached to PIC 720 in a manner enables the connection component 750B to be received along the plane parallel to the upper surface of substrate 710.

FIG. 7C is a diagram of a device or system 700C, according to some embodiments. As shown in FIG. 7C, system 700C can include device 705C including substrate 710, at least one PIC 720, ball grid array 730 formed between substrate 710 and PIC 720, and connection component 740C integrated within device 705C. More specifically, connection component 740C is formed on PIC 720. System 700C further includes connection component 750C coupled to optical fiber 760.

In this illustrative example, connection component 740C is a female connection component having a set of openings including opening 742C. Connection component 750C is a male connection component having a set of protrusions including protrusion 752C. Each opening of the set of openings of connection component 740C is designed to receive a respective protrusion of the set of protrusions of connection component 750C. For example, opening 742C is designed to receive protrusion 752C.

System 700C enables optical fiber-to-waveguide coupling on a plane perpendicular to an upper surface of substrate 710 (e.g., vertical coupling). For example, connection component 740C is attached to PIC 720 in a manner enables the connection component 750C to be received along the plane perpendicular to the upper surface of substrate 710.

FIG. 7D is a diagram of a device or system 700D, according to some embodiments. As shown in FIG. 7D, system 700D can include device 705D including substrate 710, at least one PIC 720, ball grid array 730 formed between substrate 710 and PIC 720, and connection component 740D integrated within device 705D. More specifically, connection component 740D is formed on PIC 720. System 700D further includes connection component 750D coupled to optical fiber 760.

In this illustrative example, connection component 740D is a male connection component having a set of protrusions including protrusion 742D. Connection component 750D is a female connection component having a set of openings including opening 752D. Each opening of the set of openings of connection component 750D is designed to receive a respective protrusion of the set of protrusions of connection component 740D. For example, opening 752D is designed to receive protrusion 742D.

System 700D enables optical fiber-to-waveguide coupling on a plane perpendicular to an upper surface of substrate 710 (e.g., horizontal coupling). For example, connection component 740D is attached to PIC 720 in a manner enables the connection component 750D to be received along the plane perpendicular to the upper surface of substrate 710.

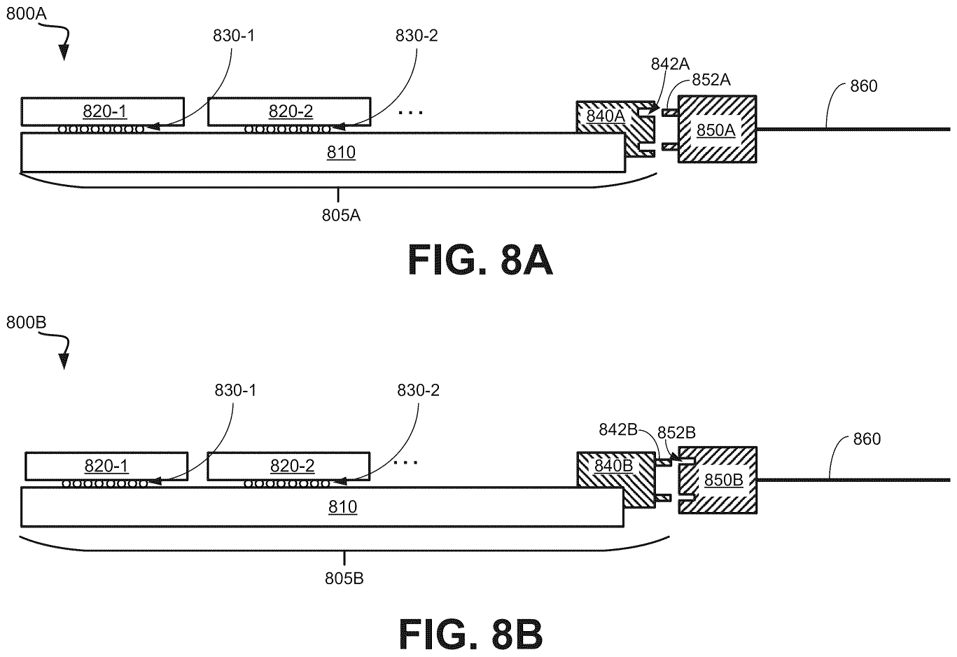

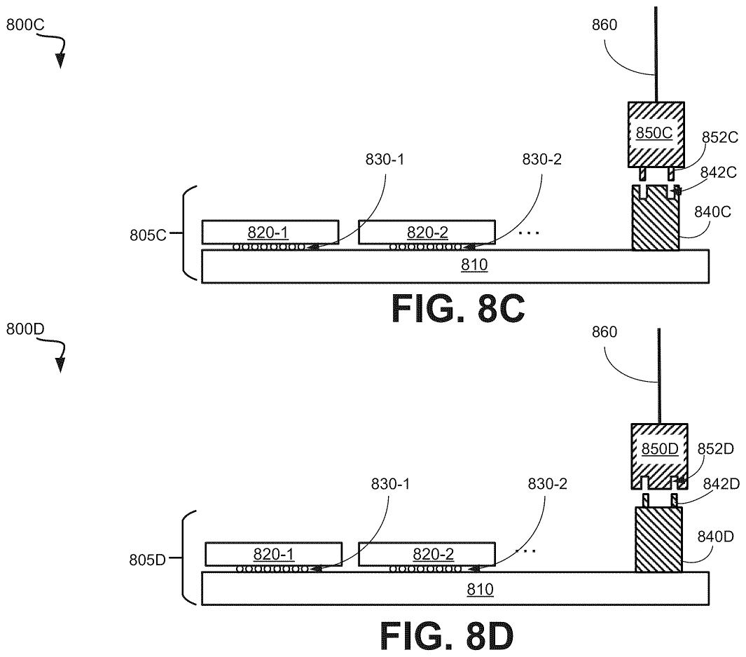

FIG. 8A is a diagram of a device or system 800A, according to some embodiments. As shown in FIG. 8A, system 800A can include device 805A including substrate 810, multiple PICS including PIC 820-1 and 820-1, multiple ball grid arrays formed between substrate 810 and respective ones of the PICS, including ball grid array 830-1 formed between substrate 810 and PIC 820-1 and ball grid array 830-2 formed between substrate 810 and PIC 820-2, and connection component 840A integrated within device 805A. More specifically, connection component 840A is formed on substrate 810. System 800A further includes connection component 850A coupled to optical fiber 860.

In this illustrative example, connection component 840A is a female connection component having a set of openings including opening 842A. Connection component 850A is a male connection component having a set of protrusions including protrusion 852A. Each opening of the set of openings of connection component 840A is designed to receive a respective protrusion of the set of protrusions of connection component 850A. For example, opening 842A is designed to receive protrusion 852A.

Similar to system 700A, system 800A enables optical fiber-to-waveguide coupling on a plane parallel to an upper surface of substrate 810 (e.g., horizontal coupling). For example, connection component 840A is attached to substrate 810 in a manner enables the connection component 850A to be received along the plane parallel to the upper surface of substrate 810.

FIG. 8B is a diagram of a device or system 800B, according to some embodiments. As shown in FIG. 8B, system 800B can include device 805B including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840B integrated within device 805B. More specifically, connection component 840B is formed on substrate 810. System 800B further includes connection component 850B coupled to optical fiber 860.

In this illustrative example, connection component 840B is a male connection component having a set of protrusions including protrusion 842B. Connection component 850B is a female connection component having a set of openings including opening 852B. Each opening of the set of openings of connection component 850B is designed to receive a respective protrusion of the set of protrusions of connection component 840B. For example, opening 852B is designed to receive protrusion 842B.

Similar to system 700B, system 800B enables optical fiber-to-waveguide coupling on a plane parallel to an upper surface of substrate 810 (e.g., horizontal coupling). For example, connection component 940B is attached to substrate 810 in a manner enables the connection component 850B to be received along the plane parallel to the upper surface of substrate 810.

FIG. 8C is a diagram of a device or system 800C, according to some embodiments. As shown in FIG. 8C, system 800C can include device 805C including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840C integrated within device 805C. More specifically, connection component 840C is formed on substrate 810. System 800C further includes connection component 850C coupled to optical fiber 860.

In this illustrative example, connection component 840C is a female connection component having a set of openings including opening 842C. Connection component 850C is a male connection component having a set of protrusions including protrusion 852C. Each opening of the set of openings of connection component 840C is designed to receive a respective protrusion of the set of protrusions of connection component 850C. For example, opening 842C is designed to receive protrusion 852C.

Similar to system 700C, system 800C enables optical fiber-to-waveguide coupling on a plane perpendicular to an upper surface of substrate 810 (e.g., vertical coupling). For example, connection component 840C is attached to substrate 810 in a manner enables the connection component 850C to be received along the plane perpendicular to the upper surface of substrate 810.

FIG. 8D is a diagram of a device or system 800D, according to some embodiments. As shown in FIG. 8D, system 800D can include device 805D including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840D integrated within device 805D. More specifically, connection component 840D is formed on substrate 810. System 800D further includes connection component 850D coupled to optical fiber 860.

In this illustrative example, connection component 840D is a male connection component having a set of protrusions including protrusion 842D. Connection component 850D is a female connection component having a set of openings including opening 852D. Each opening of the set of openings of connection component 850D is designed to receive a respective protrusion of the set of protrusions of connection component 840D. For example, opening 852D is designed to receive protrusion 842D.

System 800D enables optical fiber-to-waveguide coupling on a plane perpendicular to an upper surface of substrate 810 (e.g., horizontal coupling). For example, connection component 840D is attached to substrate 810 in a manner enables the connection component 850D to be received along the plane perpendicular to the upper surface of substrate 810.

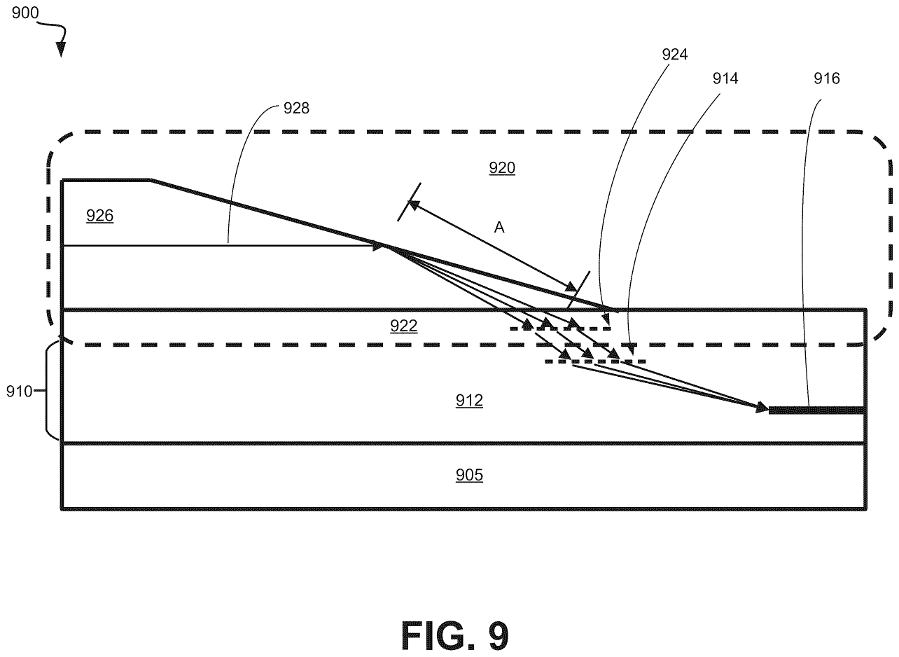

FIG. 9 is a diagram of a device or system 900, according to some embodiments. As shown in FIG. 9, system 900 can include substrate 905 and connection component 910 formed on substrate 905. Connection component 910 can include first portion of a cladding layer (“cladding layer portion”) 912, first portion of a collimator assembly (“collimator assembly portion”) 914 formed in first portion of the cladding layer 912, and waveguide 916 formed in cladding layer portion 912. System 900 can further include connection component 920 corresponding to a detachable optical fiber component. Connection component 920 can include second portion of a cladding layer (“cladding layer portion”) 922, and second portion of the collimator assembly (“collimator assembly portion”) 924 formed in cladding layer portion 912. Connection component 920 can further include angle-cleaved optical fiber 926. The collimator assembly can increase the alignment tolerance of connection component 930. In some embodiments, collimator assembly portions 914 and 920 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 μm to about 100 μm.

Optical signals 928 can travel through angle-cleaved optical fiber 926, which can, upon incidence at the interface between angle-cleaved optical fiber 926 and the surrounding environment (e.g., air), be directed toward the collimator assembly. In some embodiments, distance “A” ranges between about 300 μm to about 500 μm. In some embodiments, distance “A” is about 400 μm. Optical signals 970 can pass through the collimator assembly and can be coupled to waveguide 916. Optical signals 970 can be coupled to waveguide 916 with a small angle (e.g., less than or equal to about 20 degrees) to have a low impact on coupling loss. This can eliminate the need for a grating coupler or mirror alignment and can have relatively low loss and large 1 dB bandwidth in wavelength.

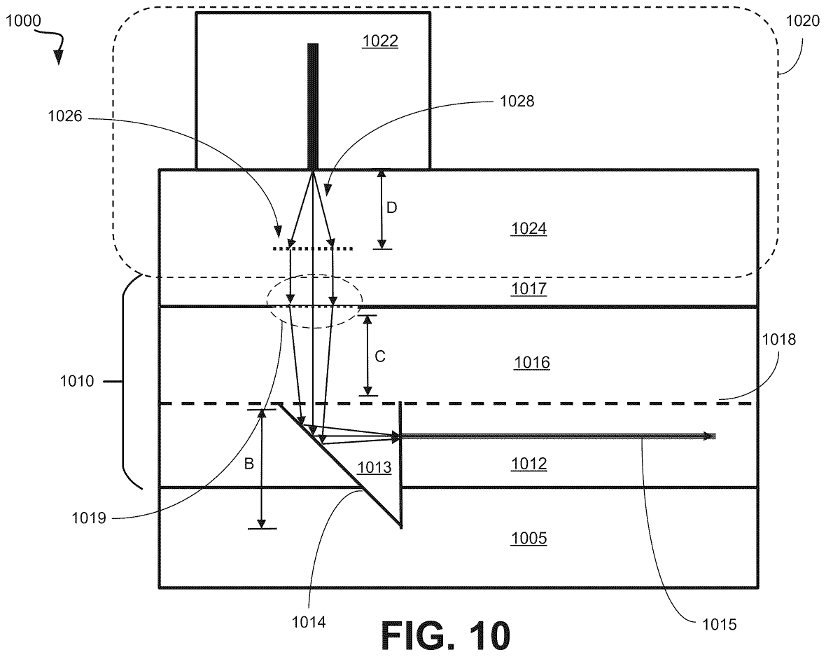

FIG. 10 is a diagram of a device or system 1000, according to some embodiments. As shown in FIG. 10, system 1000 can include substrate 1005 and connection component 1010 formed on substrate 1005. Connection component 1010 can include cladding layer 1012 formed on substrate 1005, trench 1013 formed at least through cladding layer 1012, mirror 1014 formed (e.g., coated) on a sidewall of trench 1013, and waveguide 1015 formed within cladding layer 1012. Trench 1013 can have a triangular cross-sectional shape (e.g., right triangular cross-sectional shape), and mirror 1014 can be formed on an angled sidewall of trench 1013 (e.g., the sidewall corresponding to the hypotenuse of the right triangular cross-sectional shape). In some embodiments, trench 1013 is formed by using a dry etch process. Connection component 1010 can further include a stack including substrate 1016 and portion of a second cladding layer (“cladding layer portion”) 1017 formed on substrate 1016. Cladding layer 1012 and substrate 1016 can be bonded together by bonding layer 1019. Portion of a collimator assembly (“collimator assembly portion”) 1019 can be formed between substrate 1016 and cladding layer portion 1017.

System 1000 can further include connection component 1020 corresponding to a detachable optical fiber connector including cleaved optical fiber 1022 formed on portion of the second cladding layer (“cladding layer portion”) 1024, and portion of the collimator assembly (“collimator assembly portion”) 1026 formed within cladding layer portion 1024. The collimator assembly can increase the alignment tolerance of connection component 1020. In some embodiments, collimator assembly portions 1019 and 1026 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 μm to about 100 μm.

Optical signals 1028 can travel through cleaved optical fiber 1022, which can, upon incidence at the interface between cleaved optical fiber 1022 and cladding layer 1024, be directed toward the collimator assembly. The collimator assembly can then direct optical signals 1028 toward mirror 1014. Mirror 1014 can be designed to direct optical signals 1028 toward waveguide 1015. Optical signals 1028 can be coupled into waveguide 1015 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, distance “B” ranges between about 10 μm to about 20 μm. In some embodiments, distance “B” is about 15 μm. In some embodiments, distance “C” ranges between about 600 μm to about 800 μm. In some embodiments, distance “C” is about 700 μm. In some embodiments, distance “D” ranges between about 600 μm to about 800 μm. In some embodiments, distance “D” is about 700 μm.

In some embodiments, the optical fiber 1022 is separated from the cladding layer portion 1024 by a gap. In some embodiments, the optical fiber 1022 is separated from the cladding layer portion 1024 by one or more layers.

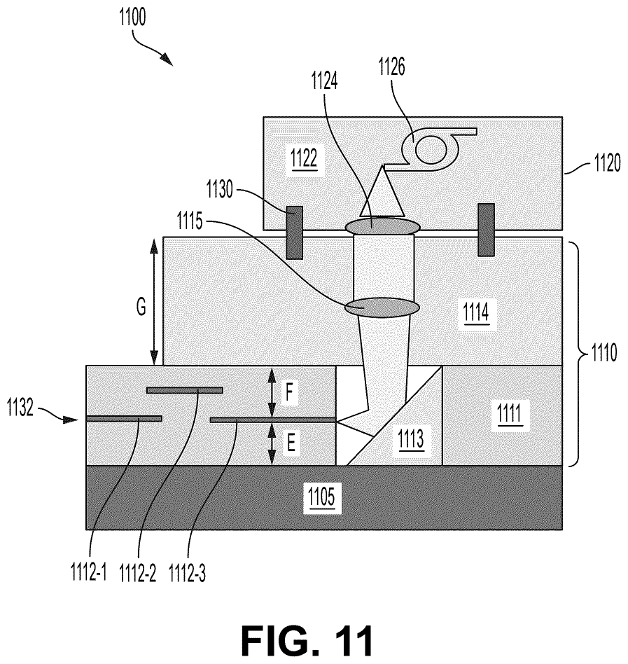

FIG. 11 is a diagram of a device or system 1100, according to some embodiments. As shown in FIG. 11, system 1100 can include substrate 1105 and connection component 1110 formed on substrate 1105. Connection component 1110 can include cladding layer 1111, a set of waveguides include waveguides 1112-1 through 1112-3 formed within cladding layer 1111, and mirror 1113 formed within cladding layer 1111 and on substrate 1105. More specifically, mirror 1113 can be formed within a trench formed within cladding layer 1111. In some embodiments, mirror 1113 is an angled mirror having a triangular cross-sectional shape (e.g., right-triangular cross-sectional shape). Connection component 1110 can further include layer 1114 formed on cladding layer 1112, and a first portion of a collimator assembly (“collimator assembly portion”) 1115 formed in layer 1114.

System 1100 can further include connection component 1120 corresponding to a detachable optical fiber component. Connection component 1120 can include cladding layer 1122, second portion of the collimator assembly (“collimator assembly portion”) 1124 formed in cladding layer 1122, and optical fiber 1126 formed in cladding layer 1122. Connection component 1120 can be attached to connection component 1110 via connectors 1130. More specifically, connectors 1130 can enable connection component 1120 to be detached from connection component 1110.

The collimator assembly can increase the alignment tolerance of connection component 930. In some embodiments, collimator assembly portions 1115 and 1124 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 μm to about 100 μm.

Optical signals 1132 can travel through the set of waveguides, which can, upon incidence upon mirror 1113, be directed toward the collimator assembly. Optical signals 1132 can pass through the collimator assembly and can be coupled to optical fiber 1126. Optical signals 1132 can be coupled to optical fiber 1126 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, distance “E” corresponding to the distance between substrate 1105 and waveguide 1112-3 ranges between about 4 μm to about 8 μm. In some embodiments, distance “E” is about 5 μm. In some embodiments, distance “F” corresponding to the distance between layer 1114 and waveguide 1112-2 ranges between about 4 μm to about 8 μm. In some embodiments, distance “F” is about 5 μm. In some embodiments, width “G” corresponding to the width of layer 1114 ranges between about 100 μm to about 500 μm. In some embodiments, each lens has a diameter that ranges between about 30 μm to about 100 μm.

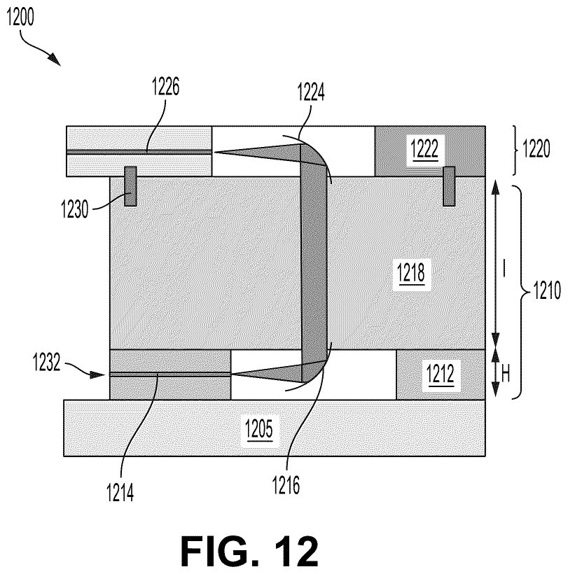

FIG. 12 is a diagram of a device or system 1200, according to some embodiments. As shown in FIG. 12, system 1200 can include substrate 1205 and connection component 1210 formed on substrate 1205. Connection component 1110 can include cladding layer 1212, waveguide 1214 formed within cladding layer 1212, and mirror 1216 formed within cladding layer 1212. More specifically, mirror 1216 can be formed within a trench formed within cladding layer 1212. In some embodiments, mirror 1216 is a concave mirror. In some embodiments, connection component 1210 further includes spacer 1218 formed on cladding layer 1212.

System 1200 can further include connection component 1220 corresponding to a detachable optical fiber component. Connection component 1220 can include cladding layer 1222, mirror 1224 formed in cladding layer 1222, and optical fiber 1226 formed in cladding layer 1222. More specifically, mirror 1224 can be formed within a trench formed within cladding layer 1222. In some embodiments, mirror 1224 is a concave mirror. Connection component 1220 can be attached to connection component 1210 via connectors 1230. More specifically, connectors 1230 can enable connection component 1220 to be detached from connection component 1210. In some embodiments, connectors 1230 are attached to spacer 1218. In some embodiments, connectors 1230 are attached to cladding layer 1212.

Optical signals 1232 can travel through waveguide 1214, which can, upon incidence upon mirror 1216, be directed toward mirror 1224. Upon incidence upon mirror 1224, optical signals 1232 can be coupled to optical fiber 1226. Optical signals 1232 can be coupled to optical fiber 1226 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, width “H” corresponding to the width of collimator layer 1212 ranges between about 20 μm to about 40 μm. In some embodiments, width “H” is about 30 μm. In some embodiments, width “I” corresponding to the width of spacer 1218 ranges between about 200 μm to about 400 μm. In some embodiments, width “I” is about 300 μm.

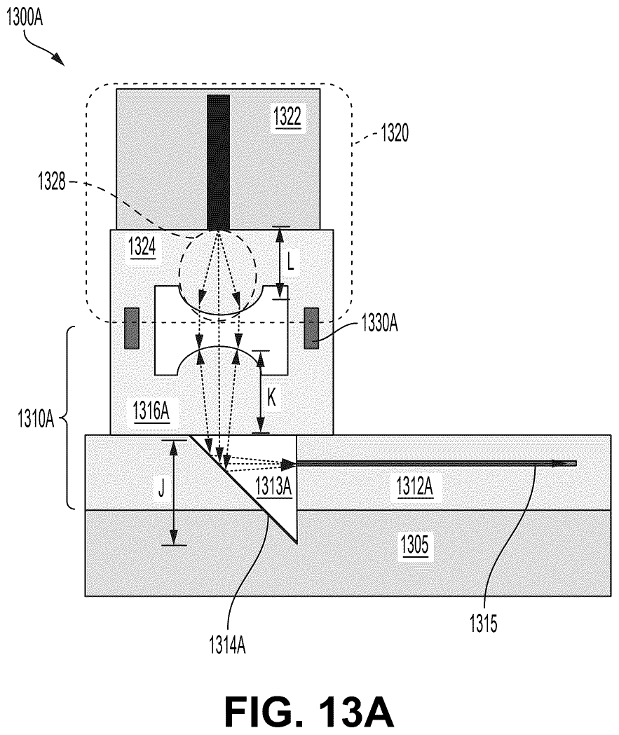

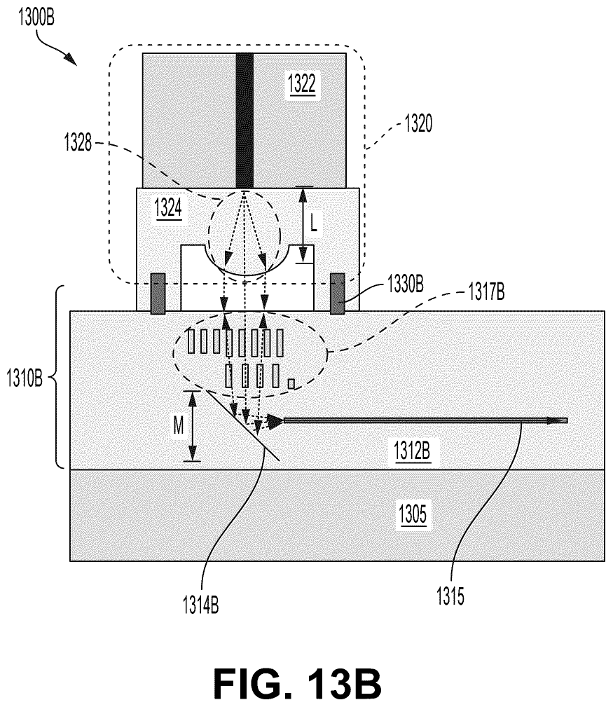

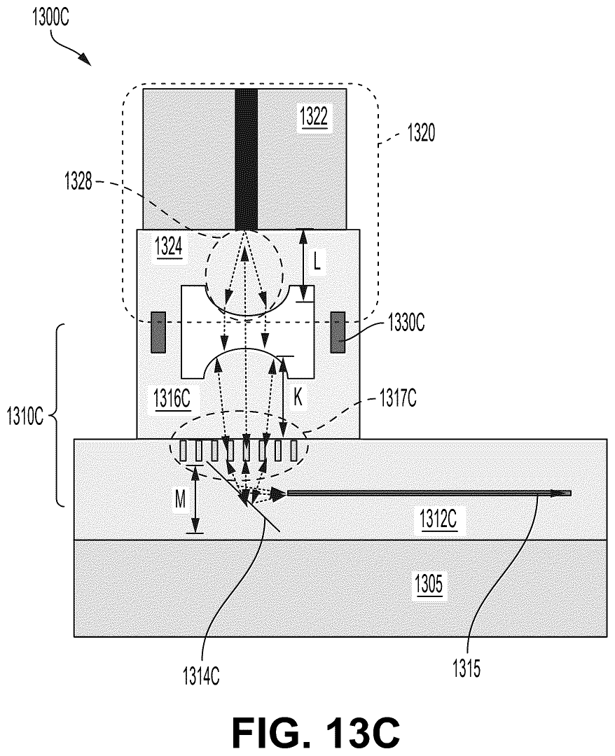

FIG. 13A is a diagram of a device or system 1300A, according to some embodiments. As shown in FIG. 13A, system 1300A can include substrate 1305 and connection component 1310A formed on substrate 1305. Connection component 1310A can include cladding layer 1312A formed on substrate 1305, trench 1313A formed at least through cladding layer 1312, mirror 1314A formed (e.g., coated) on a sidewall of trench 1313A, and waveguide 1315A formed within cladding layer 1312A. Trench 1313A can have a triangular cross-sectional shape (e.g., right triangular cross-sectional shape), and mirror 1314A can be formed on an angled sidewall of trench 1313A (e.g., the sidewall corresponding to the hypotenuse of the right triangular cross-sectional shape). In some embodiments, trench 1313A is formed by using a dry etch process. Connection component 1310A can further include microlens 1316A which forms a collimator assembly portion. In some embodiments, trench 1313A is filled with an index matched material (e.g., that matches to the index of cladding layer 1312). The Index matched material may be, for example SiOx, SiN, and/or another material.

System 1300A can further include connection component 1320 corresponding to a detachable optical fiber connector including cleaved optical fiber 1322 formed on microlens 1324. Microlens 1324 can form another collimator assembly portion. The collimator assembly can increase the alignment tolerance of connection component 1320. Accordingly, in these embodiments, the collimator assembly is a microlens assembly. In some embodiments, each lens has a diameter that ranges between about 30 μm to about 100 μm. Connection components 1310A and 1320 can be attached using mechanical connectors 1330A (e.g., pins or tubes).

Optical signals 1328 can travel through cleaved optical fiber 1322 toward the collimator assembly. The collimator assembly can then direct optical signals 1328 toward mirror 1314A. Mirror 1314A can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, at least one of the microlens 1316A or 1324 is a freeform microlens. For example, at least one of the microlens 1316A or 1324 can be a cylindrical lens if the waveguide mode is elliptical. A freeform microlens can be designed with parametric surfaces, to convert arbitrary mode shape from waveguide to a symmetric circular shape to match the mode at the fiber end.

In some embodiments, distance “J” corresponding to the height of the trench 1313A ranges between about 5 μm to about 15 μm. In some embodiments, distance “J” is about 10 μm. In some embodiments, distance “K” corresponding to the distance between the apex of microlens 1316A and the surface of cladding layer 1312A ranges between about 200 μm to about 600 μm. In some embodiments, distance “K” is about 400 μm. In some embodiments, distance “L” corresponding to the distance between the apex of microlens 1324 and cleaved optical fiber 1322 ranges between about 200 μm to about 600 μm. In some embodiments, distance “L” is about 400 μm.

In some embodiments, the optical fiber 1322 is separated from the microlens 1324 by a gap. In some embodiments, the optical fiber 1322 is separated from the microlens 1324 by one or more layers.

FIG. 13B is a diagram of a device or system 1300B, according to some embodiments. As shown in FIG. 13B, system 1300B can include substrate 1305 and connection component 1310B formed on substrate 1305. Connection component 1310B can include cladding layer 1312B formed on substrate 1305, mirror 1314B formed within cladding layer 1312B, and waveguide 1315A formed within cladding layer 1312B. Connection component 1310B can further include metalens array or stack 1317B which forms a collimator assembly portion. In some embodiments, mirror 1314B is formed in a trench formed in cladding layer 1312B, and the trench is then backfilled with an index matched material that is index matched to the cladding layer 1312B after formation of the mirror 1314B.

System 1300B can further include connection component 1320 corresponding to a detachable optical fiber connector including cleaved optical fiber 1322 formed on microlens 1324, as described above with reference to FIG. 13A. Microlens 1324 can form another collimator assembly portion. The metalens array 1317B can be used to achieve lithography-defined overlay accuracy, broadband operation over the entire original band (O-band) (e.g., wavelengths ranging from about 1260 nanometers (nm) to about 1360 nm), and high flexibility of beam shaping. A metalens can be made of any suitable material. Examples of suitable materials include silicon (Si), titanium oxide (TiO₂), etc. The collimator assembly can increase the alignment tolerance of connection component 1320. Accordingly, in these embodiments, the collimator assembly is a hybrid microlens-metalens assembly. In some embodiments, each lens has a diameter that ranges between about 30 μm to about 100 μm. Connection components 1310B and 1320 can be attached using mechanical connectors 1330B (e.g., pins or tubes).

Optical signals 1328 can travel through cleaved optical fiber 1322 toward the collimator assembly. The collimator assembly can then direct optical signals 1328 toward mirror 1314A. Mirror 1314B can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength. In some embodiments, the microlens 1324 is a freeform microlens. For example, microlens 1324 can be a cylindrical lens if the waveguide mode is elliptical.

In some embodiments, distance “M” corresponding to the height of the mirror 1314B is less than or equal to about 10 μm. In some embodiments, the distance “M” is less than or equal to about 6 μm. The distance “L” is similar to the distance “L” described above with reference to FIG. 13A.

In some embodiments, the optical fiber 1322 is separated from the microlens 1324 by a gap. In some embodiments, the optical fiber 1322 is separated from the microlens 1324 by one or more layers.

FIG. 13C is a diagram of a device or system 1300C, according to some embodiments. As shown in FIG. 13B, system 1300C can include substrate 1305 and connection component 1310C formed on substrate 1305. Connection component 1310C can include cladding layer 1312C formed on substrate 1305, mirror 1314C formed within cladding layer 1312C, and waveguide 1315A formed within cladding layer 1312C. Connection component 1310C can further include microlens 1316C and metalens array or stack 1317C which forms a collimator assembly portion. The metalens array 1317C can be used to slow down the divergence of light.

System 1300C can further include connection component 1320 corresponding to a detachable optical fiber connector including cleaved optical fiber 1322 formed on microlens 1324, as described above with reference to FIGS. 13A-13B. Microlens 1324 can form another collimator assembly portion. The collimator assembly can increase the alignment tolerance of connection component 1320. Accordingly, in these embodiments, the collimator assembly is a hybrid microlens-metalens assembly. In some embodiments, each lens has a diameter that ranges between about 30 μm to about 100 μm. Connection components 1310C and 1320 can be attached using mechanical connectors 1330C (e.g., pins or tubes).

Optical signals 1328 can travel through cleaved optical fiber 1322 toward the collimator assembly. The collimator assembly can then direct optical signals 1328 toward mirror 1314A. Mirror 1314C can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, at least one of the microlens 1316C or 1324 is a freeform microlens. For example, at least one of the microlens 1316C or 1324 can be a cylindrical lens if the waveguide mode is elliptical. The distances “M”, “K” and “L” are similar to the distances “K” and “L” described above with reference to FIGS. 13A-13B.

In some embodiments, the optical fiber 1322 is separated from the microlens 1324 by a gap. In some embodiments, the optical fiber 1322 is separated from the microlens 1324 by one or more layers.

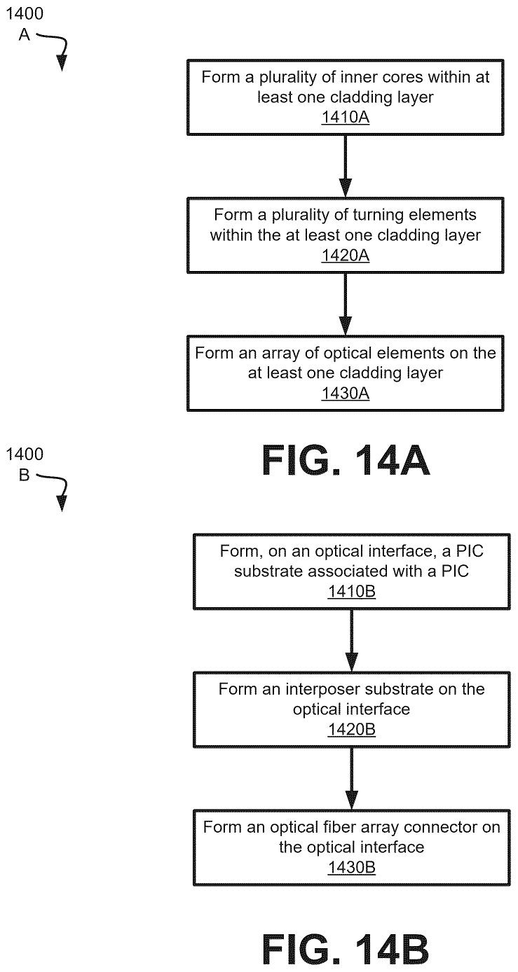

FIG. 14A is a flowchart of an example method 1400A to fabricate an optical interface including a turning element array, according to some embodiments.

At block 1410A, a plurality of inner cores is formed within at least one cladding layer. In some embodiments, the at least one cladding layer includes a first cladding layer and a second cladding layer formed on the first cladding layer, where a first plurality of inner cores is formed within the first cladding layer and a second plurality of inner cores is formed within the second cladding layer. In some embodiments, forming the second cladding layer on the first cladding layer includes hybrid bonding the second cladding layer to the first cladding layer.

At block 1420A, a plurality of turning elements is formed within the at least one cladding layer. For example, the plurality of turning elements can be formed within the first cladding layer. Each inner core of the plurality of inner cores of the at least one cladding layer (e.g., the first cladding layer) is associated with a respective turning element of the plurality of turning elements.

At block 1430A, an array of optical elements is formed on the at least one cladding layer. For example, the array of optical elements can be formed on the first cladding layer. Each optical element of the array of optical elements is associated with a respective turning element of the plurality of turning elements. Further details regarding blocks 1410A-1430A are described above with reference to FIGS. 1A-13C.

FIG. 14B is a flowchart of an example method 1400B to implement an optical interface including a turning element array, according to some embodiments.

At block 1410B, a PIC substrate associated with a PIC is formed on an optical interface. More specifically, the PIC substrate can be formed on a cladding layer of the optical interface.

At block 1420B, an interposer substrate is formed on the optical interface. More specifically, the interposer substrate can be formed on the cladding layer.

At block 1430B, an optical fiber array connector is formed on the optical interface. More specifically, the optical fiber array connector can be formed on an array of optical elements of the optical interface. Further details regarding blocks 1410B-1430B are described above with reference to FIGS. 1A-14A.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within +10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An optical interface comprising:
a plurality of inner cores of waveguides;
an array of turning elements, wherein each inner core of the plurality of inner cores is associated with a respective turning element of the array of turning elements; and
a plurality of spot size converters, wherein each spot size converter of the plurality of spot size converters is associated with a respective turning element of the array of turning elements.

2. The optical interface of claim 1, wherein at least one spot size converter of the plurality of spot size converters has a linear design.

3. The optical interface of claim 1, wherein at least one spot size converter of the plurality of spot size converters has a polynomial design.

4. The optical interface of claim 1, wherein at least one spot size converter of the plurality of spot size converters has a two-layer design.

5. The optical interface of claim 1, wherein at least one spot size converter of the plurality of spot size converters has a trident design.

6. The optical interface of claim 1, wherein the array of turning elements comprises multiple sets of turning elements, and wherein the array of turning elements has a staggered turning element design in which each turning element of a set of turning elements of the multiple sets of turning elements are arranged in a staggered formation.

7. The optical interface of claim 1, wherein the array of turning elements comprises multiple sets of turning elements, and wherein the array of turning elements has a non-staggered turning element design in which each turning element of a set of turning elements of the multiple sets of turning elements are arranged in a non-staggered formation.

8. The optical interface of claim 7, and wherein each inner core of the plurality of inner cores is an angled inner core having at least one bend.

9. The optical interface of claim 8, wherein the at least one bend has an angle that ranges from about 5° to about 45° relative to a non-bended section of the angled inner core.

10. The optical interface of claim 7, and wherein each inner core of the plurality of inner cores is an angled inner core having at least two bends.

11. A system comprising:
a photonic integrated circuit (PIC);
an optical fiber array connector associated with an optical fiber array; and
an optical interface between the PIC and the optical fiber array, wherein the optical interface comprises:
a plurality of inner cores of waveguides;
an array of turning elements, wherein each inner core of the plurality of inner cores is associated with a respective turning element of the array of turning elements; and
a plurality of spot size converters, wherein each spot size converter of the plurality of spot size converters is associated with a respective turning element of the array of turning elements.

12. The system of claim 11, wherein at least one spot size converter of the plurality of spot size converters has a linear design.

13. The system of claim 11, wherein at least one spot size converter of the plurality of spot size converters has a polynomial design.

14. The system of claim 11, wherein at least one spot size converter of the plurality of spot size converters has a two-layer design.

15. The system of claim 11, wherein at least one spot size converter of the plurality of spot size converters has a trident design.

16. The system of claim 11, wherein the array of turning elements comprises multiple sets of turning elements, and wherein the array of turning elements has a staggered turning element design in which each turning element of a set of turning elements of the multiple sets of turning elements are arranged in a staggered formation.

17. The system of claim 11, wherein the array of turning elements comprises multiple sets of turning elements, and wherein the array of turning elements has a non-staggered turning element design in which each turning element of a set of turning elements of the multiple sets of turning elements are arranged in a non-staggered formation.

18. The system of claim 17, wherein each inner core of the plurality of inner cores is an angled inner core having at least one bend.

19. The system of claim 18, wherein the at least one bend has an angle that ranges from about 5° to about 45° relative to a non-bended section of the angled inner core.

20. The system of claim 17, wherein each inner core of the plurality of inner cores is an angled inner core having at least two bends.
